(19) United States
(12) Patent Application Publication
(10) Pub. No.: US 2005/0271836 A1
(43) Pub. Date: Dec. 8, 2005

(54) Sheets for slidable heating device

(76) Inventor: Hideki Nakanishi, Osaka (JP)

Correspondence Address: BIRCH STEWART KOLASCH & BIRCH, PO BOX 747, FALLS CHURCH, VA, 22040-0747, US

(21) Appl. No.: 11/198,307

(22) Filed: Aug. 8, 2005

Related U.S. Application Data
(62) Division of application No. 10/426,627, filed on May 1, 2003.

(30) Foreign Application Priority Data
May 13, 2002 (JP) 136601/2002

(51) Int. Cl. B41M 5/30

(52) U.S. Cl. 428/32.69

(57) ABSTRACT

The present invention provides a sheet comprising a support; a first layer which is formed on one side of the support and is contactable with a slidable heating device; and a second layer which is formed on the other side of the support and is contactable with a hot-melt resin layer formed on a fabric. The sheet is interposed between the hot-melt resin layer and a heating surface of the slidable heating device, and a wrinkle in the hot-melt resin layer is smoothed out by sliding the slidable heating device under a load. The support may comprise a paper. The first and second layers may comprise a silicone compound. Further, the present invention provides a transfer kit comprising the sheet and a transfer sheet in combination, wherein the transfer sheet comprises a substrate and a transfer layer separable from the substrate, and the transfer layer is receivable an image and comprises a hot-melt adhesive particle. The sheet ensures smoothness of a wrinkle in a hot-melt resin layer formed on a fabric without damaging the hot-melt resin layer and staining a slidable heating device.

This application is a Divisional of co-pending application Ser. No. 10/426,627, filed on May 1, 2003, the entire contents of which are hereby incorporated by reference and for which priority is claimed under 35 U.S.C. § 120.

### FIELD OF THE INVENTION

The present invention relates to a sheet for smoothing out a distortion (or fold) in a hot-melt resin layer formed by thermal-transferring onto a fabric (such as a clothing) with the use of a slidable heating device (such as an iron), and a transfer kit which comprises the sheet and a transfer sheet.

### BACKGROUND OF THE INVENTION

As a method for forming an image on a fabric such as a clothing (or clothes), a method using a transfer sheet, that is, a sheet in which a separable transfer layer comprising a hot-melt resin is formed on a support, has been generally employed. This method comprises forming an image on the transfer layer of the transfer sheet, melt-separating (or melt-releasing) the transfer layer from the support by heating, and transferring the transfer layer onto a fabric for forming the image on the fabric. Since the transfer image formed by such a method usually has a distortion (or unevenness) (such as a wrinkle or a flexure) due to thermal shrinkage, it is desirable to smooth out a wrinkle, a flexure or the like with the use of an iron after transferring from the viewpoint of forming an excellent transfer image. However, in the case where the image formed by thermal-transferring is heated with the use of an iron, the transfer layer of the fabric is molten and attached to the iron, as a result the transfer image of the fabric is damaged and the iron is stained.

Meanwhile, in order to abating an effect of an iron on a clothing made from synthetic fiber(s) (denaturation or deformation of the material due to heat of the iron), a method of interposing a cloth or a mesh inorganic fiber between the iron and the clothing has been also conducted. When such a method is applied for ironing a transfer layer formed on a fabric, however, in the cloth, the transfer layer is molten and damaged, and in the mesh inorganic fiber, the wrinkle in the transfer layer not only cannot be smoothed out, the transfer layer but also is transformed into a mesh form.

### SUMMARY OF THE INVENTION

It is, therefore, an object of the present invention to provide a sheet capable of smoothing out a wrinkle (or a crinkle) in a hot-melt resin layer formed on a fabric without damaging the hot-melt resin layer and staining a slidable heating device, and a transfer kit comprising the sheet and a transfer sheet.

It is another object of the present invention to provide a sheet capable of improving an image recorded onto a hot-melt resin layer on a fabric in clearness (distinctness) or vividness (or brightness), and a transfer kit comprising the sheet and a transfer sheet.

The inventor of the present invention made intensive studies to achieve the above objects and finally found that ironing a fabric with interposing a sheet having layers at both surfaces thereof between a heating surface of an iron and a hot-melt resin layer formed on a fabric ensures smoothing out a wrinkle in the hot-melt resin layer formed on the fabric without damaging the hot-melt resin layer and staining the iron. The present invention was accomplished based on the above findings.

That is, the sheet of the present invention comprises a support, a first layer which is formed on one side of the support and is contactable with a slidable heating device, and a second layer which is formed on the other side of the support and is contactable with a hot-melt resin layer formed on a fabric, wherein the sheet is interposed between the hot-melt resin layer and a heating surface of the slidable heating device, and a wrinkle in the hot-melt resin layer is smoothed out by sliding the slidable heating device under a load. The heating surface of the slidable heating device is usually slippery relative to the first layer, and the second layer is usually non-slippery relative to the hot-melt adhesive resin layer and separable therefrom. The Clark stiffness of the sheet is about not more than 20 cm (e.g., about 5 to 20 cm). In the sheet, the coefficient of dynamic friction of the first layer may be not more than 0.4 (e.g., about 0.05 to 0.4) relative to the heating surface of the slidable heating device, the coefficient of dynamic friction of the second layer may be not less than 0.15 (e.g., about 0.15 to 5) relative to the hot-melt resin layer, and the coefficient of dynamic friction of the second layer may be larger than that of the first layer (for example, the difference between the first layer and the second layer in the coefficient of dynamic friction may be about 0.01 to 0.3). The first and the second layers may comprise a silicone compound. The support may comprise a paper. The basis weight of the paper may be about 10 to 200 g/m². The thickness of the support is about 10 to 250 μm, and the thickness of the first layer and that of the second layer are about 1 to 100 μm, respectively. The slidable heating device is usually an iron. The hot-melt resin layer may comprise a polyamide-series resin. The hot-melt resin layer may be formed by thermal-transferring an image-formed hot-melt resin layer.

The present invention also includes a method for smoothing out a wrinkle in a hot-melt resin layer formed on a fabric, which comprises interposing the sheet between the hot-melt resin layer and a heating surface of a slidable heating device, and sliding the slidable heating device under a load. The method may comprise forming an image on a transfer layer of a transfer sheet, thermal-transferring the transfer layer onto a fabric to form the hot-melt resin layer, interposing the sheet between the hot-melt resin layer and the heating surface of the slidable heating device, sliding the slidable heating device under a load to unwrinkle the hot-melt resin layer. Moreover, the present invention includes a transfer kit, which comprises the above-mentioned sheet and a transfer sheet in combination, wherein the transfer sheet comprises a substrate and a transfer layer, for forming a hot-melt resin layer, separable from the substrate, and the transfer layer is formable an image and comprises a hot-melt adhesive particle. The hot-melt adhesive particle may comprise a hot-melt adhesive particle having a melting point (e.g., about 90 to 150° C.) which is higher than a heating temperature of the transfer layer, and a hot-melt adhesive particle having a melting point (e.g., about 40 to 80° C.) which is not higher than the heating temperature.

### DETAILED DESCRIPTION OF THE INVENTION

The sheet of the present invention is interposed between a hot-melt resin layer formed on a fabric and a heating surface of a slidable heating device to smooth out a distortion (such as a wrinkle or a flexure (or a deflection)) in the hot-melt resin layer by sliding the slidable heating device under a load. Moreover, the sheet comprises a support, a first layer which is formed on one side of the support and is contactable with the slidable heating device, and a second layer which is formed on the other side of the support and is contactable with the hot-melt resin layer.

(Support)

The support may have such flexibility as to transform a form thereof along with transformation of the hot-melt resin layer (that is, to have adaptability (or follow-up property) to the hot-melt resin layer). More specifically, the support has a Clark stiffness of not more than 20 cm (e.g., about 5 to 20 cm), preferably not more than 19 cm (e.g., about 10 to 19 cm), and more preferably not more than 18 cm (e.g., about 10 to 18 cm). As such a support, for example, there may be mentioned a paper, a fabric (such as a woven fabric or a nonwoven fabric), a chemical (artificial) fiber paper, a synthetic paper, a plastic film, and others.

The paper includes a paper obtained from a mechanical pulp, a chemical pulp (such as a sulfite pulp or a kraft pulp), a semi-chemical pulp, a used paper pulp, and others. As the paper, for example, there may be mentioned a non-coated paper for printing (e.g., a ground wood printing paper, a woody paper, a Kent paper), a coated paper for printing (e.g., an art paper, a coated paper, a cast-coated paper), an unbleached wrapping (or packing) paper (e.g., a both surface-woody kraft paper, a ribbed kraft paper, a machine glazed kraft paper), a bleached wrapping (or packing) paper (e.g., a pure-white roll paper, a both surface-woody bleached kraft paper, a machine glazed bleached kraft paper), a thin paper (e.g., a glassine paper, a rice paper, an India paper, a condenser paper), and others. The paper may be subjected to an anchor treatment (e.g., clay-coat) to facilitate formation of a first or second layer.

Exemplified as the fiber constituting the woven fabric or the nonwoven fabric is a natural fiber (e.g., a cotton, a hemp, a silk, a sheep wool, a cellulose fiber), a regenerate fiber (e.g., a rayon such as a viscose rayon), a synthetic fiber (e.g., a cellulose ester-series fiber such as an acetylcellulose fiber), and others.

As a chemical fiber paper, there may be mentioned, a variety of chemical fiber papers using a chemical fiber (such as the above-mentioned synthetic fiber) as a raw material.

As a polymer constituting the synthetic paper or the plastic sheet, there may be exemplified a cellulose derivative (e.g., a cellulose acetate), a polyalkylene arylate-series resin (e.g., a polyethylene terephthalate, apolybutylene terephthalate), a fluorine-containing resin (e.g., a polyvinylidene fluoride), and others.

Among them, from the viewpoint of an excellent balance among thermal resistance, thermal denaturation and adaptability, the paper or the fabric is preferred, and in terms of convenience and economical efficiency, the paper (e.g., a wrapping paper such as a kraft paper) is usually available.

The thickness of the support may be such an extent that heat of the iron is efficiently propagated to the hot-melt resin. The thickness of the support is, for example, about 10 to 250 μm, preferably about 15 to 200 μm, and more preferably about 20 to 150 μm.

The basis weight of the support (in particular a paper) may be selected within the range of about 10 to 200 g/m². The low basis weight is preferable from the viewpoint of adaptability, and for example, the basis weight is about 10 to 100 g/m², preferably about 20 to 80 g/m², and more preferably about 30 to 70 g/m².

(First Layer)

The support is imparted at least sliding properties for the heating surface of the slidable heating device on one side of the support.

The first layer is formed on one side of the support to improve sliding properties on the heating surface of the slidable heating device. The first layer may be formed like a layer on at least the support surface. For example, the support may have the first layer formed on a surface thereof, or whole of the support may be impregnated into a component constituting the first layer.

Moreover, the first layer preferably has such flexibility as to have adaptability to the hot-melt resin layer without melting by heating the slidable heating device.

Concretely, the Clark stiffness of the first layer is not more than 20 cm (e.g., about 5 to 20 cm), preferably not more than 19 cm (e.g., about 10 to 19 cm), and more preferably not more than 18 cm (e.g., 10 to 18 cm).

Further, the first layer preferably has such thermal resistance that the first layer does not be molten by heating with the use of the slidable heating device. For example, the first layer is preferably composed of a compound which is not molten over 100° C., preferably over 120° C., and more preferably over 150° C. (in particular 200° C.).

As the compound constituting the first layer, for example, there may be mentioned a silicone compound, a fluorine-containing resin (e.g., a vinylidene fluoride-series resin, an ethylene fluoride-propylene fluoride-series resin, a fluorine-containing oligomer), and others. Among these resins, it is particularly preferred to use the silicone compound.

The silicone compound includes a compound containing a polyorganosiloxane. The polyorganosiloxane may be a linear, branched or meshed (cancellate) compound having a Si—O bond (siloxane bond), and may be composed of a unit represented by the formula: RₐSiO_{(4-a)/2}.

In the above formula, the group R includes, for example, a C₁₋₁₀alkyl group such as a methyl group, an ethyl group, a propyl group and a butyl group; a halogenated C₁₋₁₀alkyl group such as a 3-chloropropyl group and a 3,3,3-trifluoropropyl group; a C₂₋₁₀alkenyl group such as a vinyl group, an allyl group and a butenyl group; a C₆₋₂₀aryl group such as a phenyl group, a tolyl group and a naphthyl group; a C₃₋₁₀cycloalkyl group such as a cyclopentyl group and a cyclohexyl group; a C₆₋₁₂aryl-C₁₋₄alkyl group such as a benzyl group and a phenethyl group; and others. The preferred group R includes a methyl group, a phenyl group, an alkenyl group (such as a vinyl group), and a fluoroC₁₋₆alkyl group. The coefficient “a” is a number of 0 to 3.

As the polyorganosiloxane, for example, there may be mentioned a polydialkylsiloxane (preferably a polydiC₁₋₁₀alkylsiloxane) such as a polydimethylsiloxane; a polyalkylalkenylsiloxane (preferably a polyC₁₋₁₀ alkylC₂₋₁₀alkenylsiloxane) such as a polymethylvinylsiloxane; a polyalkylarylsiloxane (preferably a polyC₁₋₁₀alkylC₆₋₂₀arylsiloxane) such as a polymethylphenylsiloxane; a polydiarylsiloxane (preferably a polydiC₆₋₂₀arylsiloxane) such as a polydiphenylsiloxane; a copolymer composed of the above-mentioned polyorganosiloxane unit [e.g., a dimethylsiloxane-methylvinylsiloxane copolymer, a dimethylsiloxane-methylphenylsiloxane copolymer, a dimethylsiloxane-methyl(3,3,3-trifluoropropyl)siloxane copolymer, a dimethylsiloxane-methylvinylsiloxane-methylphenylsilox ane copolymer]; and others.

The silicone compound may be a polyorganosiloxane having a substituent [e.g., an epoxy group, a hydroxyl group, an alkoxy group, a carboxyl group, an amino group or a substituted amino group (such as a dialkylamino group), an ether group, a (meth)acryloyl group] in an end or main chain thereof insofar the silicone compound does not lose releasability thereof. Moreover, the both ends of the silicone compound may, for example, be a trimethylsilyl group, a dimethylvinylsilyl group, a silanol group, a triC₁₋₂alkoxysilyl group, and others.

Exemplified as the industrially available silicone compound is, concretely, a silicone oil, a silicone rubber, a silicone resin, and the like.

The silicone oil is a compound mainly composed of a linear polymer having a low degree of polymerization, and for example, the viscosity of the silicone oil is about 5 to 1000000 mPa·s at 25° C. As the silicone oil, there may be mentioned, for example, a dimethylsilicone oil, a methylphenylsilicone oil, a methylhydrogensilicone oil, a cyclic polydimethylsiloxane, an alkyl-modified silicone oil, an amino-modified silicone oil, a silicone-polyether copolymer, a fatty acid-modified silicone oil, an epoxy-modified silicone oil, a fluorosilicone oil, and others.

The silicone rubber is a compound obtained by vulcanizing a linear polymer having a high degree of polymerization, and is usually linear, but not particularly limited, may have partially a branched structure or may be branched. As the silicone rubber, for example, there may be mentioned a methylsilicone rubber, a vinylsilicone rubber, a phenylsilicone rubber, a phenylvinylsilicone rubber, a fluorine-containing silicone rubber, and others.

The silicone resin has a crosslinked three-dimensional structure. Exemplified as the silicone resin is a silicone varnish, a modified silicone varnish (an alkyd resin-modified varnish, a polyester resin-modified varnish, an epoxy resin-modified varnish, an acrylic resin modified varnish, a urethane resin-modified varnish), a silicone molding compound containing an inorganic filler, and others.

Among these silicone compounds, the silicone oil is preferred from the viewpoint of releasability. The silicone compound(s) may be used singly or in combination.

(Second Layer)

In order to improve releasability (or separating properties) of the sheet from the hot-melt resin layer formed on the fabric after heating, the second layer is formed on the other side of the support. The relationship between the support and the second layer is similar to that between the support and the first layer.

The second layer also preferably has such flexibility as to have adaptability to the hot-melt resin layer without melting by heating the slidable heating device as the same manner as in the first layer. Accordingly, it is also preferred that the second layer is similar to the first layer in the Clark stiffness and thermal resistance (hot-melt temperature). As the compound constituting the second layer, a compound similar to the compound exemplified in the first layer may be used.

The thickness of the first layer and that of the second layer are, for example, about 1 to 100 μm, preferably about 3 to 50 μm, and more preferably about 5 to 20 μm, respectively.

(Sheet)

According to the sheet of the present invention, it is preferred that the first layer is excellent in sliding properties on the heating surface of the slidable heating device and that the second layer shows a constant adhesiveness to the hot-melt resin layer. That is, it is preferred that the second layer is stationary adhered to the hot-melt resin layer even when the slidable heating device is moved and pressed on the first layer. To that end, it is necessary that the coefficient of dynamic friction of the second layer relative to the hot-melt resin layer is larger than that of the first layer relative to the heating surface of the slidable heating device.

Specifically, the coefficient of dynamic friction of the first layer relative to the heating surface of the slidable heating device is not more than 0.4 (e.g., about 0.05 to 0.4), preferably not more than 0.35 (e.g., about 0.1 to 0.35), and more preferably not more than 0.3 (e.g., about 0.15 to 0.3). Incidentally, the coefficient of dynamic friction may, for example, be measured by use of a slidable heating device such as an iron of which the heating surface is not subjected to a special treatment (e.g., a fluorine processing).

The coefficient of dynamic friction of the second layer relative to the hot-melt resin layer is not less than 0.15 (e.g., about 0.15 to 0.5), preferably not less than 0.2 (e.g., about 0.2 to 0.4), and more preferably not less than 0.25 (e.g., about 0.25 to 0.35). Incidentally, the coefficient of dynamic friction may, for example, be measured by use of a hot-melt resin such as a hot-melt adhesive resin (e.g., a polyamide-series resin).

To improve releasability (or separating properties) from the hot-melt resin layer, the component constituting the second layer has specifically a coefficient of dynamic friction of not more than 0.6, preferably not more than 0.5, and more preferably not more than 0.4 relative to the hot-melt resin layer. Further, to make the second layer being stationary adhered to the hot-melt resin layer even when the iron is moved on the first layer, it is preferred that the coefficient of friction of the second layer relative to the hot-melt resin layer is larger than that of the first layer relative to the heating surface of the iron.

The above coefficient of dynamic friction of the second layer is larger than that of the first layer, and the difference between the both dynamic frictions is, for example, about 0.01 to 0.3, preferably about 0.03 to 0.2, and more preferably about 0.05 to 0.15.

The thickness of the sheet may be such an extent that heat of the slidable heating device is propagated to the hot-melt resin. For example, the thickness of the sheet is about 20 to 300 μm, preferably about 30 to 250 μm, and more preferably about 50 to 200 μm.

To improve adaptability to the hot-melt resin layer, the Clark stiffness of the sheet is not more than 20 cm (e.g., about 5 to 20 cm), preferably not more than 19 cm (e.g., about 10 to 19 cm), more preferably about not more than 18 cm (e.g., about 10 to 18 cm).

As a production method of the sheet of the present invention, there may be exemplified a method of coating both sides of the support with a liquid coating composition which contains a compound constituting the first and second layers by a conventional manner such as roller coating, air knife coating, blade coating, rod coating, bar coating, comma coating or graver coating; a method of spraying both sides of the support with a liquid coating composition which contains a liquid compound constituting the first and second layers by means of a spray; a method of impregnating a liquid coating composition which contains a compound constituting the first and second layers into the support; and others.

The sheet of the present invention is employed for smoothing out a distortion (such as a wrinkle or a flexure) in a hot-melt resin layer formed on a fabric with the use of a slidable heating device. Specifically, the distortion in the hot-melt resin layer can be smoothed out by sliding the slidable heating device under a load with interposing the sheet of the present invention between the hot-melt resin layer formed on the fabric and the heating surface of the slidable heating device. Thus, the wrinkle or the flexure in the hot-melt resin layer is smoothed out by sliding the slidable heating device under a load, and as a result, a uniform (or even) layer is formed (or obtained) on the fabric. Since the hot-melt resin layer usually has an image drawn with an ink thereon, the image is improved in clearness or vividness by smoothing out the distortion in the hot-melt resin layer. The slidable heating device includes various members, such as an iron.

The hot-melt resin layer comprises a hot-melt adhesive resin, for example, a polyamide-series resin. The thickness of the hot-melt resin layer is about 5 to 90 μm, and preferably about 10 to 70 μm.

The heating temperature of the slidable heating device is, for example, about 100 to 200° C., preferably about 110 to 180° C., and more preferably about 120 to 160° C. (particularly about 120 to 150° C.). The pressure applied on the slidable heating device is about 10 to 20000 Pa, preferably about 100 to 10000 Pa, and more preferably about 500 to 10000 Pa (particularly about 500 to 8000 Pa).

[Transfer Kit]

The transfer kit of the present invention comprises the above-mentioned sheet and a transfer sheet in combination. The transfer sheet is a sheet for forming a hot-melt resin layer on a fabric (such as clothes). The transfer sheet comprises a substrate, and an image-receivable transfer layer separable from the substrate and containing a hot-melt adhesive particle.

Examples of the substrate constituting the transfer sheet usually include a release (releasable) substrate, for example, a release-treated paper (a release paper); a synthetic paper, a chemical (artificial) fiber paper and a plastic film, each may be treated for providing releasability. The thickness of the substrate is usually about 10 to 250 μm, and preferably about 15 to 200 μm.

The hot-melt adhesive particle contained in the transfer layer includes a particle of a polyamide-series resin, a thermoplastic polyurethane-series resin, a polyester-series resin, an olefinic resin, and others. Among these resins, a polyamide-series resin (e.g., a nylon 6, a nylon 46, a nylon 66, a nylon 610, a nylon 612, a polyamide-series elastomer) is preferred, and in particular the preferred polyamide-series resin includes a nylon having at least one unit selected from a unit constituting a nylon 11 and a unit constituting a nylon 12 (e.g., a homopolyamide such as a nylon 11 and a nylon 12, a copolyamide such as a nylon 6/11, a nylon 6/12, a nylon 66/12, and a copolymer of a dimer acid, a diamine and a laumlactam or an aminoundecanoic acid), and a polyamide resin formed by reacting a dimer acid with a diamine.

The melting point of the hot-melt adhesive particle is about 40 to 200° C., and preferably about 60 to 150° C. The mean particle size of the hot-melt adhesive particle is, for example, about 10 to 200 μm, and preferably about 30 to 150 μm. The oil absorption of the hot-melt adhesive particle is about 5 to 500 ml/100 g, and preferably about 10 to 300 ml/100 g. Incidentally, the oil absorption is a value measured by use of linseed oil in accordance with JIS K 5107.

Further, the hot-melt adhesive particle preferably includes a hot-melt adhesive particle (A) having a melting point (e.g., about 90 to 150° C., preferably about 90 to 120° C., and more preferably about 100 to 120° C.) which is higher than the heating temperature of the transfer layer, and a hot-melt adhesive particle (B) having a melting point (e.g., about 40 to 80° C., preferably about 50 to 80° C., and more preferably about 60 to 80° C.) which is not higher than the heating temperature. The heating temperature of the transfer layer is usually a temperature for drying the transfer layer coated on the sheet to form a film (e.g., about 70 to 90° C.).

The mean particle size of the hot-melt adhesive particle (A) is about 10 to 200 μm, preferably about 30 to 100 μm, and more preferably about 40 to 80 μm. Moreover, the hot-melt adhesive particle (A) may comprise a hot-melt adhesive particle having an oil absorption of not less than 50 ml/100 g (e.g., a porous particle) and a hot-melt adhesive particle having an oil absorption of less than 50 ml/100 g. The mean particle size of the hot-melt adhesive particle (B) is also similar to that of the hot-melt adhesive particle (A). The ratio (weight ratio) of the hot-melt adhesive particle (A) relative to the hot-melt adhesive particle (B) [the former/the latter] is about 99.5/0.5 to 50/50, and preferably about 99/1 to 70/30.

The transfer layer may comprise a film-formable resin component [e.g., a hydrophilic polymer, a urethane-series resin, a thermosetting or crosslinkable (crosslinking) resin], a dye fixing agent, and various additives in addition to the above-mentioned hot-melt adhesive particle.

As the hydrophilic polymer, a polyoxyalkylene glycol-series resin is preferred. The polyoxyalkylene glycol-series resin preferably includes a polyoxyalkylene glycol-series resin having an oxyethylene unit, for example, a polyethylene glycol (homopolymer); a copolymer of an ethylene oxide and at least one member selected from a C₃₋₄alkylene oxide, a hydroxyl group-containing compound (e.g., a polyhydric alcohol such as glycerin, trimethylolpropane, trimethylolethane, and bisphenol A), a carboxyl group-containing compound (e.g., a C₂₋₄carboxylic acid such as acetic acid, propionic acid, and butyric acid), and an amino group-containing compound (e.g., amine, ethanolamine); or others. The weight-average molecular weight of the hydrophilic polymer is about 500 to 10000, and preferably about 1000 to 5000.

The urethane-series resin is preferably a polyester-based urethane-series resin obtained with the use of at least a polyester diol (in particular, an aliphatic polyester diol obtained with use of an aliphatic component as a main reaction component) [for example, a polyester diol obtained by reacting a C₂₋₆alkylene diol such as 1,4-butandiol, with a C₄₋₁₂aliphatic dicarboxylic acid (such as adipic acid) and isophthalic acid or phthalic acid]. Moreover, it is preferred that the urethane-series resin is used as an organic solvent solution, an aqueous solution, and an aqueous emulsion. Further, the urethane-series resin may be a cationic urethane-series resin having a tertiary amino group or a quaternary ammonium salt introduced into a molecule thereof.

As the thermosetting or a crosslinkable resin, a self-crosslinkable (self-crosslinking) resin (a thermoplastic resin having a self-crosslinking group), for example, a self-crosslinking polyester-series resin, a self-crosslinking polyamide-series resin, a self-crosslinking acrylic resin, a self-crosslinking olefinic resin and the like are preferred. Among them, a self-crosslinking acrylic resin (e.g., an acrylic silicone resin) is particularly preferred.

In the film-formable resin component, the combination use of the hydrophilic polymer and the urethane-series resin is particularly preferred. The ratio (weight ratio) of the hydrophilic polymer relative to the urethane-series resin [the former/the latter] is about 90/10 to 10/90, and preferably about 70/30 to 30/70.

Exemplified as the dye fixing agent is a cationic compound (a dye fixing agent having a low molecular weight), a polymeric dye fixing agent, and others. Among these dye fixing agents, a cationic compound, in particular a quaternary ammonium salt is preferred.

The ratio of the hot-melt adhesive particle is about 200 to 1000 parts by weight, and preferably about 300 to 1000 parts by weight on solid basis relative to 100 parts by weight of the film-formable resin component. The ratio of the dye fixing agent is about 10 to 100 parts by weight, and preferably about 10 to 60 parts by weight on solid basis relative to 100 parts by weight of the film-formable resin component.

In the transfer sheet, a protecting layer separable from the substrate may be disposed between the substrate and the transfer layer. As the protecting layer, a urethane-series resin (e.g., a thermoplastic urethane-series resin) and/or cationic resin, in particular, a cationic thermoplastic urethane-series resin (e.g., a polyester-based urethane-series resin which is obtained with the use of a diol component containing an aliphatic polyester diol of not less than 50% by weight, and has a tertiary amino group or a quaternary ammonium salt introduced into a molecule thereof) is preferred since such a resin has high wettability or compatibility toward a substrate and protects the transfer layer efficiently. The thickness of the protecting layer is about 0.1 to 10 μm, and preferably about 1 to 5 μm.

The method for forming a hot-melt resin layer with the above-mentioned transfer sheet usually comprises recording an image onto the transfer layer of the above-mentioned transfer sheet with the use of an ink (e.g., an aqueous ink or an oil-based ink by an ink jet printing or recording), heating (melting by heating) the transfer layer with contacting with an object, and separating the transfer layer from the substrate to transfer the record image to the object. In the case where the transfer layer of the transfer sheet is thermal-transferred by this method, a distortion (such as a wrinkle or a flexure) is generated on the transferred hot-melt resin layer due to thermal shrinkage. The distortion can be smoothed out with the use of a slidable heating device and the sheet of the present invention by the method mentioned above.

The method for recording an image onto a transfer layer includes a conventional recording manner, for example, an inkjet printing (recording) system, a sublimation-mode thermal-transfer printing (recording) system, or other manner. Among them, an inkjet printing (recording) system is preferred from the viewpoint of convenience or others.

The sheet of the present invention ensures smoothness of a distortion (such as a wrinkle or a flexure) in a hot-melt resin layer formed on a fabric without damaging the hot-melt resin layer and staining a slidable heating device to be used. Moreover, the sheet of the present invention realizes improvement in clearness or vividness of an image recorded onto the hot-melt resin layer formed on the fabric.

### EXAMPLES

The following examples are intended to describe this invention in further detail and should by no means be interpreted as defining the scope of the invention. Incidentally, unless otherwise indicated, “part(s)” indicates the proportion by weight. Moreover, a method for transferring with a transfer sheet in Examples and Comparative Examples, description of sheets for iron, the manner of ironing with the sheets for ironing, and methods for evaluating various characteristics or properties are shown as follows.

[Method for Transferring Transfer Sheet]

(Characteristics of Components Constituting Transfer Layer of Transfer Sheet)
Nylon 12 particle (manufactured by Daicel Huels, Co. Ltd., Bestamelt 430-PO₆, melting point of 110° C., mean particle size of 60 μm): 43 parts by weight
Nylon 12 particle (manufactured by Daicel Huels, Co. Ltd., Bestamelt 640-P1, melting point of 76° C., mean particle size of 100 μm): 7.6 parts by weight
Urethane-series resin emulsion (manufactured by Shin-nakamura Chemical Corporation, SP resin ME-307): 21 parts by weight
Polyethylene glycol (manufactured by Sanyo Chemical Industries, Ltd., PEG4000S): 15.4 parts by weight
Dye fixing agent (manufactured by Senka, Co. Ltd., PAPIOGEN P109, a quaternary ammonium salt-containing compound): 8.5 parts by weight

(Transfer Method)

An A-4 size transfer sheet was printed with the use of an ink jet printer (manufactured by Canon, Inc., BJF-900, transfer paper mode). Then, a T-shirt and the printed transfer sheet were put on a platform balance in that order, and ironed over a whole area thereof at a constant pressure for about 5 seconds every part to be ironed as a rough standard by use of the platform balance. Thereafter, the release paper was separated from the transfer sheet to complete transferring.

[Sheet for Ironing]
Sheet 1 for ironing: manufactured by Lintec Corporation, KA7W white V10
Sheet 2 for ironing: manufactured by Lintec Corporation, BK6RB (S5)
Sheet 3 for ironing: manufactured by Lintec Corporation, SGP-850KT-T
Plain paper: manufactured by Canon Sales Co., Inc., Office Planner QOPMA4

[Manner of Ironing]

The T-shirt on which the transfer layer was transferred was placed on a platform balance to be laid with the transfer layer up, and a sheet for ironing was placed on the transfer layer. The sheet was ironed over a whole area thereof at a temperature of 160° C. and a pressure of 40 Pa with a scale of the platform balance maintaining at a constant value with the use of an iron (manufactured by Toshiba Corporation, TA-D23).

[Ironing Workability]

Ironing was conducted according to the foregoing manner of ironing, and the ironing workability was evaluated on the basis of the following criteria.
“A”: ironing was smoothly conducted
“B”: it was difficult to slide the iron, and the contact of the iron was partially lacking in uniformity
“C”: it was impossible to slide the iron, and there was no ironing

[Releasability (or Separating Properties) after Ironing]

The release strength between the sheet for ironing and the transfer layer of the T-shirt was measured after ironing in accordance with JIS K 6854, and evaluated based on the following criteria.
“A”: less than 490 mN/25 mm width
“B”: not less than 490 mN/25 mm width and less than 980 mN/25 mm width
“C”: not less than 980 mN/25 mm width

[Clark Stiffness]

The Clark stiffness of the sheet was measured with a Clark stiffness-measuring machine (manufactured by Tester Sangyo Co., Ltd.) in accordance with JIS P 8143.

[Adaptability of Transfer Layer]

Ironing was conducted according to the above-mentioned manner of ironing, and the adaptability (or follow-up property) of the transfer layer of the T-shirt to the iron was evaluated on the basis of the following criteria.
“A”: the transfer layer is adaptable to the iron enough, and wrinkles were totally smoothed out
“B”: the transfer layer come short of adaptability to the iron in parts, and wrinkles were not smoothed out completely and the transfer layer was lacking in uniformity
“C”: wrinkles were hardly smoothed out

### Example 1

A sheet 1 for ironing was interposed between a transfer layer formed on a T-shirt and a heating surface of an iron, and the T-shirt was ironed. Table 1 shows evaluation results of sliding properties between the sheet for ironing and the surface of the iron, and the ironing workability. Table 2 shows evaluation results of the sliding properties between the sheet for ironing and the transfer layer, and the ironing workability. Table 3 shows evaluation results of the releasability after ironing, the Clark stiffness of the sheet, and the adaptability.

### Example 2

A T-shirt was ironed and the properties mentioned above were evaluated in the similar manner as in Example 1 except that the sheet 2 for ironing was used instead of the sheet 1 for ironing. The results are shown in Tables 1 to 3.

### Example 3

A T-shirt was ironed and the properties mentioned above were evaluated in the similar manner as in Example 1 except that the sheet 3 for ironing was used instead of the sheet 1 for ironing. The results are shown in Tables 1 to 3.

### Comparative Example 1

A T-shirt was ironed and the properties mentioned above were evaluated in the similar manner as in Example 1 except that the plain paper was used instead of the sheet 1 for ironing. The results are shown in Tables 1 to 3.

TABLE 1

| | Coefficient of | Coefficient of | Ironing |
|---|---|---|---|
| | static friction | dynamic friction | workability |
| Example 1 | 0.23 | 0.23 | A |
| Example 2 | 0.18 | 0.2 | A |
| Example 3 | 0.19 | 0.21 | A |
| Comparative | 0.7 | 0.73 | C |
| Example 1 | | | |

TABLE 2

| | Coefficient of | Coefficient of | Ironing |
|---|---|---|---|
| | static friction | dynamic friction | workability |
| Example 1 | 0.33 | 0.3 | A |
| Example 2 | 0.29 | 0.3 | A |
| Example 3 | 0.31 | 0.28 | A |
| Comparative | 0.87 | 0.91 | C |
| Example 1 | | | |

TABLE 3

| | | Clark stiffness | |
|---|---|---|---|
| | Releasability | (cm) | Adaptability |
| Example 1 | A | 13.2 | A |
| Example 2 | A | 17 | A |
| Example 3 | A | 20.2 | B |
| Comparative | C | 18.1 | A |
| Example 1 | | | |

As apparent from Tables 1 to 3, in the case where ironing is conducted by interposing any one of the sheets for iron of Examples 1 to 3, the ironing workability, the releasability after ironing, and the adaptability of the transfer layer are excellent. On the other hand, in Comparative Example 1 using the plane paper, sufficient ironing workability and releasability after ironing cannot be obtained.

1. A transfer kit, which comprises a smoothing sheet and a transfer sheet in combination,
wherein the smoothing sheet comprising
a support,
a first layer which is formed on one side of the support and is contactable with a slidable heating device, and
a second layer which is formed on the other side of the support and is contactable with a hot-melt resin layer formed on a fabric,
wherein the smoothing sheet is interposed between the hot-melt resin layer and a heating surface of the slidable heating device, and a wrinkle in the hot-melt resin layer is smoothed out by sliding the slidable heating device under a load,
wherein the transfer sheet comprises a substrate and a transfer layer, for forming a hot-melt resin layer, separable from the substrate, and the transfer layer is formable an image and comprises a hot-melt adhesive particle.

2. A transfer kit according to claim 1, wherein the first layer is slippery relative to the heating surface of the slidable heating device, and the second layer is non-slippery relative to the hot-melt adhesive resin layer and separable therefrom.

3. A transfer kit according to claim 1, wherein the smoothing sheet has a Clark stiffness of not more than 20 cm.

4. A transfer kit according to claim 1, wherein the coefficient of dynamic friction of the first layer is not more than 0.4 relative to the heating surface of the slidable heating device, the coefficient of dynamic friction of the second layer is not less than 0.15 relative to the hot-melt resin layer, and the coefficient of dynamic friction of the second layer is larger than that of the first layer.

5. A transfer kit according to claim 1, wherein the first and the second layers comprise a silicone compound.

6. A transfer kit according to claim 1, wherein the support comprises a paper.

7. A transfer kit according to claim 1, wherein the thickness of the support is 10 to 250 μm, and the thickness of the first layer and that of the second layer are 1 to 100 μm, respectively.

8. A transfer kit according to claim 1, wherein the slidable heating device is an iron.

9. A transfer kit according to claim 1, wherein the hot-melt resin layer comprises a polyamide-series resin.

10. A transfer kit according to claim 1, wherein the hot-melt resin layer is formed by thermal-transferring an image-formed hot-melt resin layer.

11. A transfer kit according to claim 1, wherein the smoothing sheet has a Clark stiffness of 5 to 20 cm, wherein the support comprises a paper having the basis weight of 10 to 200 g/m², and the coefficient of dynamic friction of the second layer relative to the hot-melt resin layer is larger than that of the first layer relative to the heating surface of the slidable heating device.

12. A transfer kit according to claim 11, wherein the coefficient of dynamic friction of the first layer relative to the heating surface of the slidable heating device is 0.05 to 0.4, that of the second layer is 0.15 to 5 relative to the hot-melt resin layer, and the difference between the first layer and the second layer in the coefficient of dynamic friction is 0.01 to 0.3.
